(19) United States
(12) Patent Application Publication
(10) Pub. No.: US 2005/0232677 A1
(43) Pub. Date: Oct. 20, 2005

(54) Roll paper holding mechanism and printer

(75) Inventors: Takeshi Ogawa, Shizuoka (JP); Yasufumi Mochizuki, Shizuoka (JP); Yuji Masuda, Shizuoka (JP)

Correspondence Address: PEARNE & GORDON LLP, 1801 EAST 9TH STREET, SUITE 1200, CLEVELAND, OH, 44114-3108, US

(73) Assignee: Star Micronics Co., Ltd., Shizuoka-shi (JP)

(21) Appl. No.: 11/108,524

(22) Filed: Apr. 18, 2005

(30) Foreign Application Priority Data
Apr. 20, 2004 (JP) 2004-123691

(51) Int. Cl. B41J 15/04

(52) U.S. Cl. 400/611; 400/693

(57) ABSTRACT

Pressing plates press side faces of a roll paper loaded into a roll paper holder unit of the drop-in type, thereby preventing overrun of the roll paper caused by an inertia force from occurring. Each of the pressing plates is urged by two coil springs which are placed respectively on inner and outer circumference sides of the roll paper. The coil spring on the outer circumference side has a higher elasticity than the coil spring on the inner circumference side. According to the configuration, the pressing force of the pressing plates due to the elasticity of the coil springs is gradually reduced in accordance with reduction of a diameter of the roll paper.

### BACKGROUND OF THE INVENTION

1. Field of the Invention

The present invention relates to a roll paper holding mechanism which rotatably holds a roll paper at a predetermined position, the roll paper being rotated by pulling out a leading portion of the paper, and more particularly to a roll paper holding mechanism having a structure which presses a side face of a roll paper. The invention relates also to a printer including such a roll paper holding mechanism.

2. Description of the Related Art

In small printers and the like, such a roll paper is often used. The roll paper is rotatably held by a structure of the drop-in type in which the roll paper is dropped in a housing space, or of the shaft-supporting type in which a core member is supported by a shaft, and then the paper is pulled out by a motor to be subjected to a printing process. When the paper is pulled out in order to conduct a printing process, the roll paper is rotated. Even when the printing process is ended, however, there is a case where an inertia force corresponding to the weight acts on the roll paper, and the rotation of the roll paper is not stopped simultaneously with the end of the printing process, so that overrun in which the rotation is continued by a certain degree occurs. The overrun causes slack in an outer circumferential portion of the roll paper. Such slack may produce wrinkles or a bend in the paper. Therefore, a structure which is provided with an elastic member that always presses a side face of a roll paper to restrict overrun has been proposed (for example, see JP-A-8-217294 (Abstract, FIG. 1(b), etc.)).

### SUMMARY OF THE INVENTION

As disclosed in JP-A-8-217294, when the side face of the roll paper is pressed by the elastic member, it is certainly possible to prevent overrun from occurring. In this case, however, the elastic member exhibits a constant elasticity, and hence the pressing force by which the side face of the roll paper is pressed is always constant. By contrast, as the roll paper is further consumed, the outer diameter becomes smaller, and the weight is further reduced. Therefore, the following disadvantages may occur.

In order to pull out the paper of the roll paper to which a constant load (pressing force) is applied by the elastic member, a driving force that must be large as the diameter of the roll paper is reduced must be applied. This phenomenon is caused because, as the distance between the rotation center of the roll paper and the outermost portion from which the paper is pulled out is longer, the force required for pulling out can be further reduced by the function of a moment force. When the diameter of the roll paper is considerably reduced, therefore, the load of the motor for pulling out the paper is excessively increased, thereby causing a possibility that a failure such as step out occurs. In order to prevent such a failure from occurring, a motor of a large driving force may be disposed. In this case, however, the production cost is increased.

In the case of the drop-in type (as disclosed in JP-A-8-217294), the roll paper which is in an initial use condition and hence heavy is always settled by its own weight in a bottom portion of a housing space. When consumption of the paper is advanced and the weight of the roll paper is reduced, however, the whole roll paper is pulled by the operation of pulling out the paper to be raised, and the raised state is held by the elastic member, so that the roll paper is hardly returned by its own weight to the bottom portion of the housing space. When the paper is pulled out in this state and a printing process is conducted while the roll paper is rotated, the print surface of the paper is rubbed, or wrinkles or a bend is produced in the paper. In the case where a sensor which detects that the paper amount is reduced and informs of the reduction in order to promote replacement of the paper is disposed on the side face of the roll paper, the sensor may malfunction because the roll paper does not exist at a predetermined position.

Therefore, it is an object of the invention to provide a roll paper holding mechanism in which over run can be effectively prevented from occurring, the paper can be pulled out by a driving force that is constant or substantially constant irrespective of the outer diameter and weight of the roll paper that vary in accordance with consumption, so that a driving unit such as a motor for pulling out the paper can stably operate, and the production cost does not become disadvantageous, and also a printer including such a roll paper holding mechanism.

A roll paper holding mechanism according to the invention is characterized in that the roll paper holding mechanism includes: a holding unit which rotatably holds a roll paper; a driving unit which pulls out a leading portion of the roll paper held by the holding unit; and a pressing unit which presses a side face of the roll paper held by the holding unit, wherein the pressing unit includes a pressing force adjusting section for gradually reducing a pressing force in accordance with reduction of a diameter of the roll paper.

According to the roll paper holding mechanism of the invention, the roll paper is rotatably held by the holding unit. The holding unit may be of the drop-in type or the shaft-supporting type. The leading portion of the roll paper held by the holding unit is pulled out by the driving unit, and, in accordance with the pulling out, the roll paper is rotated. Even when the pulling operation is stopped, overrun which is caused to occur by an inertia force can be restricted because the side face of the roll paper is pressed by the pressing unit.

In the invention, the pressing force of the pressing unit is gradually reduced in accordance with reduction of the diameter of the roll paper. This change of the pressing force is realized by the pressing force adjusting section. The leading portion of the roll paper is pulled out by the driving unit configured by a motor and the like. As described above, in a state where a load is applied by the pressing unit, a driving force required for pulling out the paper must be large as the diameter of the roll paper is reduced.

In the invention, however, unlike the conventional art, the load which is applied to the roll paper by the pressing unit is not constant, but is gradually reduced in accordance with reduction of the diameter of the roll paper. Specifically, in “state where the roll paper has a large diameter and the driving force for pulling out can be reduced,” the pressing unit exerts a large pressing force, and, in “state where the roll paper has a small diameter and the driving force for pulling out must be large,” the pressing force of the pressing unit is reduced. Therefore, the driving force required for pulling out the paper (this force matches the load applied to the driving unit) may be constant or substantially constant irrespective of the outer diameter and weight of the roll paper. As a result, even when the diameter of the roll paper is reduced, an excessive load is not applied to the driving unit, and a stable operation of pulling the roll paper can be attained. Moreover, it is possible to avoid a cost for enabling the driving unit to cope with an excessive load.

In the case where the holding unit for roll paper is of the drop-in type, when the diameter of the roll paper is reduced and also the weight is reduced, there may arise a failure that, as described above, the roll paper is raised by the operation of pulling out the paper and the raised state is held by the pressing unit. In the invention, however, the pressing force which is applied to the roll paper by the pressing unit is gradually reduced in accordance with reduction of the diameter of the roll paper. Even when the roll paper is reduced in diameter and weight, therefore, the own weight of the roll paper overcomes the pressing force of the pressing unit, and hence the roll paper can be returned to the bottom portion of the housing space. Consequently, the failure due to the state where the roll paper remains to be raised can be prevented from occurring.

More specific modes of the roll paper holding mechanism of the invention are as follows.

The pressing force adjusting section includes a plurality of elastic members which are arranged substantially along a direction of reducing the diameter of the roll paper, and in a sequence in which an elasticity is further reduced as advancing in the diameter reducing direction.

The pressing unit includes a pressing member which butts against the side face of the roll paper, and the pressing force adjusting section includes a swinging mechanism which gradually swings the pressing member in one direction in accordance with reduction of the diameter of the roll paper.

The pressing unit includes a pressing member which butts against the side face of the roll paper, and the pressing force adjusting section includes a link mechanism which urges the pressing member by a pressure corresponding to an own weight of the roll paper.

The invention is characterized in that the pressing force of the pressing unit which presses the side face of roll paper held by the holding unit is gradually reduced by the pressing force adjusting section in accordance with reduction of the diameter of the roll paper. According to the configuration, first, overrun of the roll paper by an inertia force can be effectively prevented by the pressing unit from occurring. Moreover, irrespective of the outer diameter and weight of the roll paper which vary in accordance with consumption, paper can be pulled out by a driving force that is constant or substantially constant. As a result, the driving unit can stably operate, and increase of the cost of the driving unit can be avoided.

### BRIEF DESCRIPTION OF THE DRAWINGS

FIG. 1 is a perspective view showing a state where a cover of a printer according to a first embodiment of the invention is closed;

FIG. 2 is a perspective view showing a state where the cover of the printer of the first embodiment is opened;

FIG. 3 is a side sectional view showing the state where the cover of the printer of the first embodiment is closed;

FIGS. 4(a) to 4(d) are plan sectional views showing the configuration and function of a pressing unit in the first embodiment;

FIGS. 5(a) to 5(d) are plan sectional views showing the configuration and function of a pressing unit in a second embodiment of the invention;

FIG. 6 is a side view of a roll paper holding mechanism according to a third embodiment of the invention;

FIG. 7(a) is a front sectional viewof the roll paper holding mechanism of the third embodiment and showing a state where the diameter of roll paper is maximum, and FIG. 7(b) is a front sectional view showing a state where the diameter of roll paper is small;

FIG. 8 is a side view of a roll paper holding mechanism according to a fourth embodiment of the invention; and

FIG. 9(a) is a front sectional view of the roll paper holding mechanism of the fourth embodiment and showing a state where the diameter of roll paper is maximum, and FIG. 9(b) is a front sectional view showing a state where the diameter of roll paper is small.

### DETAILED DESCRIPTION OF THE PREFFERED EMBODIMENTS

Hereinafter, embodiments of the invention will be described with reference to the accompanying drawings.

### (1) First Embodiment

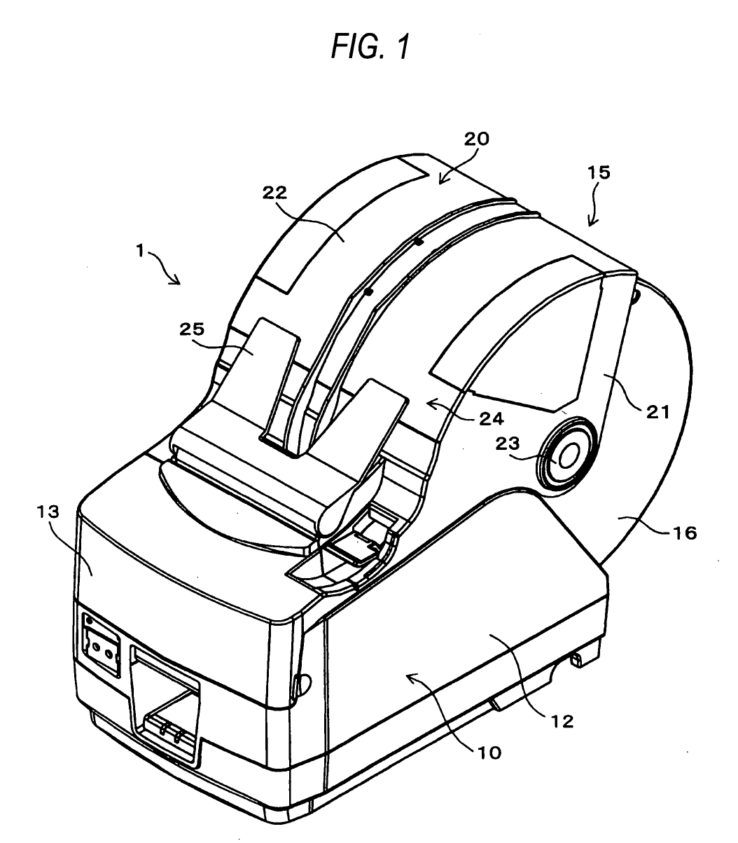

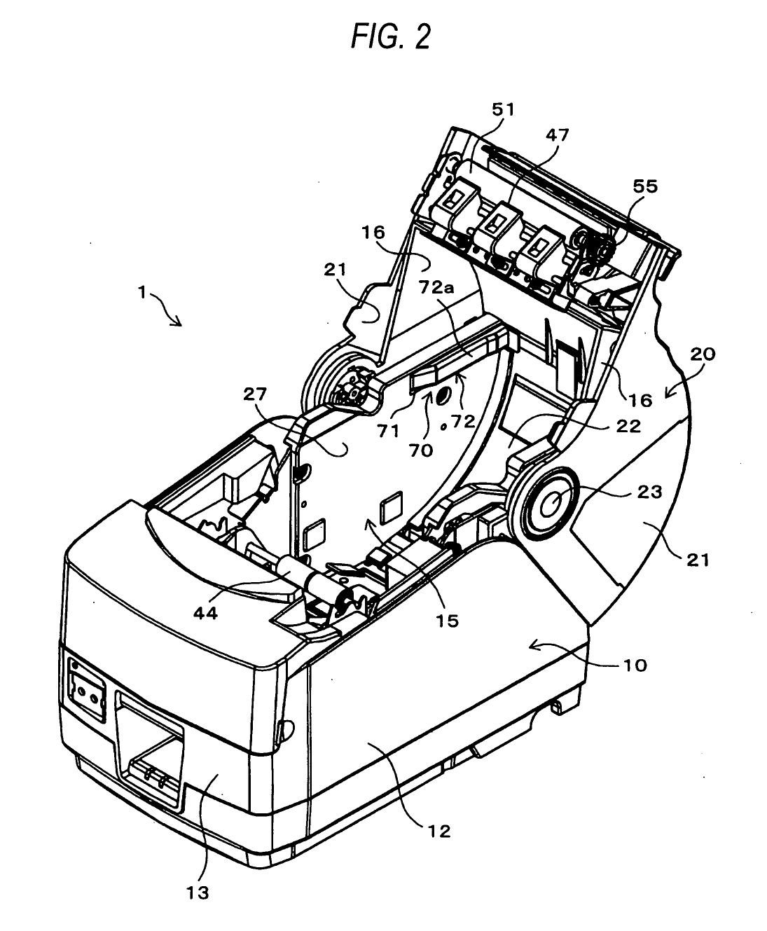

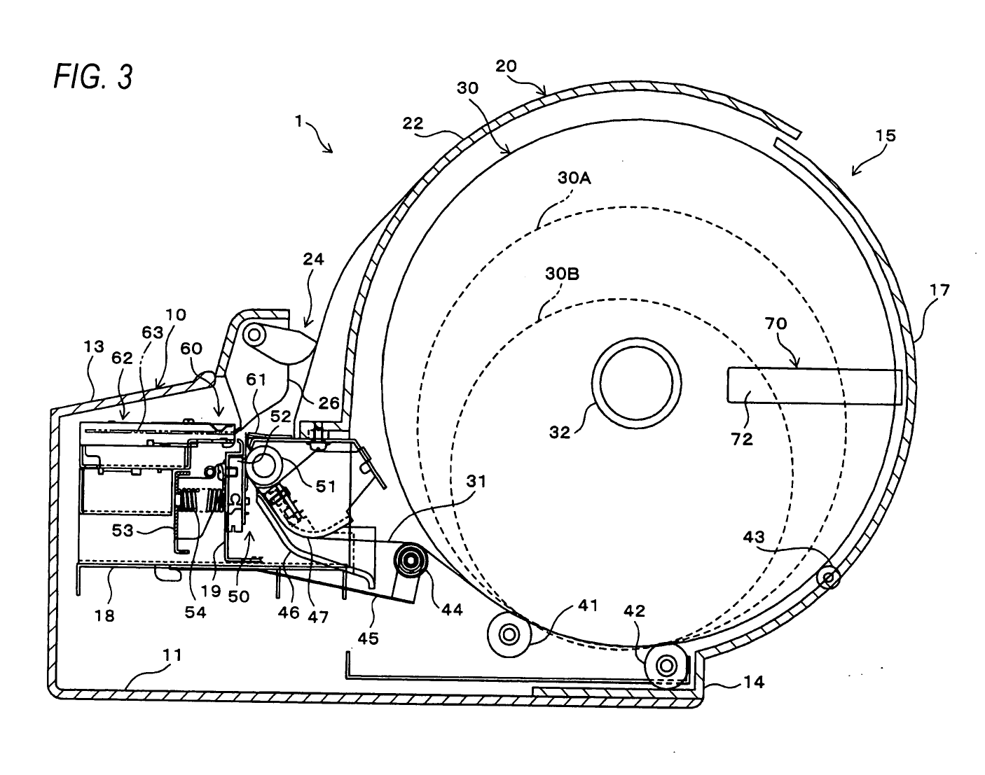

FIG. 1 shows a small printer which is preferably used in an electronic cash register or the like. In a printer 1, the external shape is formed by an outer case 10 and a cover 20 which is openably attached to the outer case 10. FIG. 1 is a perspective view showing a state where the cover 20 is closed, and FIG. 2 is a perspective view showing a state where the cover 20 is opened. FIG. 3 is a side sectional view showing the state where the cover 20 is closed.

As shown in FIGS. 1 to 3, the outer case 10 has a box-like shape including a bottom plate 11, a pair of right and left side plates 12, a front plate 13, and a back plate 14. A roll paper holder unit (holding unit) 15 which has a substantially semi cylindrical shape is formed in rear of the case. The roll paper holder unit 15 is of the drop-in type in which a roll paper 30 is dropped to be loaded, and formed by: right and left rear plates 16 which have a substantially sector shape, and which are formed in rear of the side plates 12 (the rear side in FIGS. 1 and 2, and the right side in FIG. 3); and a curved plate 17 which connects together arcuate peripheral edges of the rear plates 16. As shown in FIG. 3, the roll paper 30 in which a thermal paper 31 is stored with being wound around a core member 32 is dropped and loaded into the roll paper holder unit 15 in a posture in which the axial direction of the core member 32 is parallel to the lateral direction, a leading portion of the paper 31 to be pulled out is placed in a lower side, and the leading portion is to be pulled out toward the front side (the front side in FIGS. 1 and 2, and the left side in FIG. 3).

As shown in FIG. 3, three rollers 41, 42, 43 in which the axis elongates in the lateral direction are rotatably supported on a bottom portion of the roll paper holder unit 15. The rollers 41 to 43 are longitudinally arranged at adequate intervals, and along the circumferential direction of the loaded roll paper 30. The roll paper 30 is placed on the rollers 41 to 43 so as to be axially rotatable. When the paper 31 is forward pulled out, the roll paper 30 is rotated, and also the rollers 41 to 43 are rotated in accordance with the rotation. Namely, the rollers 41 to 43 enable the roll paper 30 to be smoothly rotated. When the roll paper 30 which is in a nonuse condition and hence has the largest diameter (in FIG. 3, indicated by the solid line) is loaded, the outer circumferential face of the roll paper 30 is placed on all the rollers 41 to 43. When the diameter is reduced as a result of consumption, the roll paper 30 is caused by the own weight to be placed on the front and center rollers 41, 42. In FIG. 3, broken lines 30A, 30B indicate states where the diameter of the roll paper is reduced.

As shown in FIGS. 1 to 3, the cover 20 is formed into a substantially semi cylindrical shape which is similar to the roll paper holder unit 15, and which is slightly larger than the roll paper holder unit 15. The cover is mounted so as to, in an opened state, cover the outer side of the roll paper holder unit 15. Specifically, the cover 20 includes: a pair of right and left side plates 21 having a substantially sector shape; and a curved plate 22 which connects together arcuate peripheral edges of the side plates 21. In each of the side plates 21, a portion corresponding to the axis of the curved plate 22 is supported swingably and coaxially via a cover shaft 23 by the corresponding rear plate 16 of the roll paper holder unit 15.

When the cover 20 is rearward swung, the cover 20 is opened along the outer side of the roll paper holder unit 15, so that, as shown in FIG. 2, an opening of the outer case 10 (this opening is formed mainly by an opening of the roll paper holder unit 15) is opened. When the cover 20 in this state is swung to the front side, the opening of the outer case 10 is closed as shown in FIGS. 1 and 3. In a state where the cover 20 is fully closed, the roll paper holder unit 15 and the cover 20 cooperate so as to form a rear portion of the printer 1 into a cylindrical shape. In the fully closed state of the cover 20, an engaging and disengaging member which is not shown is disengageably engaged with the outer case 10, so that the fully closed state is maintained by the engaged state.

As shown in FIG. 3, the printer 1 includes: a printing mechanism 50 which conducts a printing process on the paper 31 that is pulled out from the roll paper 30; and a press-cutting type cutter mechanism 60 which cuts the paper 31 that has been subjected to the printing process. The printing mechanism 50 is configured by: a platen roller 51 which is attached to a tip end portion of the cover 20 serving as a rotational end portion; and a thermal print head 52 which is attached to a frame 18 fixed to a front portion in the outer case 10. The print head 52 is supported by a head frame 19. The print head 52 and the head frame 19 are always urged toward the platen roller 51 by a coil spring 54 which is attached to a spring frame 53 fixed to the frame 18.

When the cover 20 is closed, the platen roller 51 is opposed to the print head 52, and the print head 52 is elastically brought into press contact with the platen roller 51 by the elasticity of the coil spring 54. The paper 31 pulled out from the roll paper 30 is interposed between the platen roller 51 and the print head 52, and then further pulled out by rotation of the platen roller 51. When the paper 31 is pulled out, the roll paper 30 is rotated.

As shown in FIG. 2, a driven gear 55 is coaxially fixed to one end portion of the shaft of the platen roller 51. When the cover 20 is fully closed, the driven gear 55 meshes with a reduction gear which is incorporated in the outer case 10 to be driven by a transportation motor (both the reduction gear and the motor are not shown). When the transportation motor operates in this state, the platen roller 51 is rotated in the transport direction of the paper 31 (clockwise in FIG. 3). In the following description, the terms of up stream and downstream mean the directions in a transport path for the paper 31, respectively.

The cutter mechanism 60 is disposed immediately downstream (the upper side in FIG. 3) from the printing mechanism 50, and configured by: a stationary blade 61 which is fixed to the tip end portion of the cover 20; and a movable blade unit 62 which is fixed to the frame 18 in the outer case 10. The movable blade unit 62 includes a movable blade 63 which is driven so as to longitudinally reciprocate. When the cover 20 is closed, the stationary blade 61 is opposed to the movable blade 63 across a gap through which the paper 31 can pass. When the movable blade 63 is rearward moved, the blade edge slides over the upper face of the stationary blade 61 while being pressingly contacted therewith. As a result of this operation, the paper 31 interposed between the blades 61, 63 is cut.

A pair of guide plates 46, 47 which guide the paper 31 to the printing mechanism 50 are disposed upstream from the printing mechanism 50. The one guide plate 46 is disposed on the outer case 10, and the other guide plate 47 on the tip end portion of the cover 20. In a state where the cover 20 is closed, the paper transport path which is narrow, and which guides a leading portion of the paper 31 toward the printing mechanism 50 is formed between the guide plates 46, 47. A tension roller 44 which pushes up the paper 31 to apply tension to the paper is disposed upstream from the guide plate 46 on the side of the outer case 10. The tension roller 44 is upward urged by a plate spring 45 disposed on the outer case 10.

As shown in FIG. 1, a paper stocker 24 is formed on the outer circumferential face of the tip end portion of the cover 20. Paper sheets each of which has been subjected to the printing process by the printing mechanism 50 and then cut away by the cutter mechanism 60 are sequentially overlappingly stored on the stocker so as to extend along the curved plate 22 of the cover 20. The paper sheets stored on the paper stocker 24 are held by a presser plate 25. As shown in FIG. 3, a guide plate 26 which guides the paper 31 to the paper stocker 24 is formed in the tip end portion of the cover 20 and downstream from the cutter mechanism 60.

The basic operations of the printer 1 in a process from printing to cutting of paper will be described. The printer 1 is caused to automatically operate by a control unit which is disposed in, for example, the outer case 10.

In the state where the cover 20 is opened, first, the user pulls out a leading portion of the paper 31 from the roll paper 30 loaded in the roll paper holder unit 15, to the outside of the outer case 10, and then closes the cover 20. When the cover 20 is closed, the paper 31 pulled out from the roll paper 30 is interposed, as advancing from the upstream side, between the guide plate 46 and the guide plate 47, the platen roller 51 and the print head 52, the stationary blade 61 and the movable blade 63, and an opening edge of the outer case 10 and a tip end edge of the cover 20.

Thereafter, the cutter mechanism 60 operates so that the movable blade 63 of the movable blade unit 62 reciprocates to cut the leading portion of the paper 31, and the printer then enters a print waiting state. Although the leading portion of the cut paper 31 is interposed between the opening edge of the outer case 10 and the tip end edge of the cover 20, the leading portion can be removed away by pulling out the paper to the outside.

The printing process is started by supplying a printing command to the print head 52 and the transportation motor. Specifically, the printing process is conducted by repeating a printing operation by the print head 52, and an operation of transporting the paper 31 by rotation of the platen roller 51. In accordance with the transportation of the paper 31, the paper 31 is transported to the paper stocker 24 while being guided by the guide plate 26.

When the printing process is ended, the platen roller 51 is rotated by a degree corresponding to a predetermined length to transport the paper 31 so as not to cut a printed portion. Thereafter, the cutter mechanism 60 operates to cut the paper 31. The cut paper 31 is stored on the paper stocker 24.

In the roll paper holder unit 15 of the printer 1, disposed is a pressing unit 70 which presses the side faces of the roll paper 30 loaded in the roll paper holder unit 15. This pressing unit 70 will be described in detail.

As shown in FIG. 2, inner plates 27 are stretched over and fixed to the inner face extending from the side plates 12 of the outer case 10 to the rear plates 16 of the roll paper holder unit 15, with forming a gap between the inner plates, and the side plates 12 and the rear plates 16. The inner plates 27 are fixed to the side plates 12, respectively. A cutaway 71 which has a thin and rectangular shape, and which longitudinally elongates is formed in a rear portion of each of the inner plates 27. A rear-end portion of the cutaway is formed to extend to the curved plate 17 of the roll paper holder unit 15. Pressing plates (pressing members) 72 are fitted into the cutaways 71, respectively.

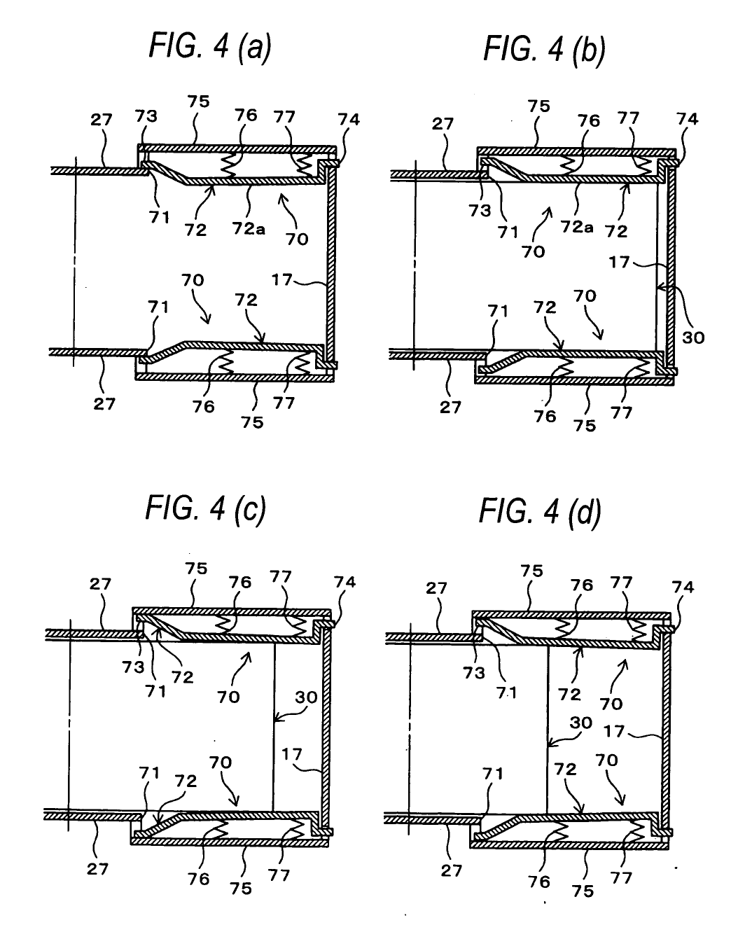

Each of the pressing plates 72 is an elongated plate member having a U-like sectional shape, and has a pressing face 72a which is inward directed. As shown in FIG. 4(a), a front-end portion of the pressing plate 72 is inclined so as to be outward expanded as forward advancing, and a rear-end portion is outward bent into a crank shape. Claws 73, 74 are formed in the end portions, respectively. The claws 73, 74 of the front- and rear-end portions of the pressing plate 72 are inserted from the inner side into front- and rear-end portions of the cutaway 71, respectively, whereby the pressing plate is fitted into the cutaway 71. A spring seat plate 75 is disposed outside the cutaway 71 with forming a predetermined gap between the plate and the pressing plate 72.

The spring seat plate 75 extends between edges of the inner plate 27 and the curved plate 17, and is fixed thereto. The pressing plate 72 is movable in lateral directions (vertical directions in FIG. 4(a)), and always inward urged by two or front and rear coil springs (elastic members) 76, 77 which are interposed between the pressing plate 72 itself and the spring seat plate 75, and the front and rear claws 73, 74 are engaged with the outer face of the inner plate 27 and the edge of the curved plate 17, respectively, whereby the fitting into the cutaway 71 is maintained.

As shown in FIG. 4(a), the outer face of the inner plate 27 with which the front claw 73 is engaged is positioned slightly more inward than the edge of the curved plate 17 with which the rear claw 74 is engaged. As shown in FIG. 4(a), therefore, in a state where the roll paper holder unit 15 is empty, the pressing face 72a of the pressing plate 72 which is inward directed is inclined so as to gradually inward protrude as forward advancing, and the whole pressing face 72a slightly inward protrudes from the inner face of the inner plate 27, so that the pressing face can butt against a side face of the roll paper 30.

As shown in FIG. 3, the pressing plates 72 are placed with respect to the roll paper 30 which is loaded in the roll paper holder unit 15, and which has the maximum outer diameter, so as to extend along a substantially horizontal radial direction that is directed from the outer circumferential edge of the roll paper 30 to the core member 32. The pressing plates have a length which is longer than a half of the radius of the roll paper 30, or which is, for example, about ¾ of the radius. When the roll paper 30 is loaded into the roll paper holder unit 15, the pressing plates 72 are pushed by the side faces of the roll paper 30 to be slightly outward moved. As a result, the pressing faces 72a of the pressing plates 72 each of which is inward urged by the two coil springs 76, 77 are in close contact with the side faces of the roll paper 30, respectively, whereby the side faces are pressed.

The two coil springs 76, 77 which are longitudinally arranged at an adequate interval have different elasticity, or the coil spring 77 in the rear side (the side of the outer circumference of the roll paper 30) exhibits an elasticity which is larger than that of the coil spring 76 in the front side (the side of the inner circumference of the roll paper 30). As shown in FIG. 4(b), when the roll paper 30 has the maximum diameter (the state indicated by the solid line 30 in FIG. 3), both the two coil springs 76, 77 are opposed to the side face of the roll paper 30 across the pressing plate 72. In this state, the side face of the roll paper 30 is pressed by the pressing plate 72 which receives mainly the force of the coil spring 77 that exhibits the higher elasticity, and that is on the outer circumference side. In FIGS. 4(a) to 4(d), the one-dot chain line shows the axis of the roll paper 30.

As shown in FIG. 4(c), then, the diameter of the roll paper 30 is reduced to about a half as a result of consumption of the paper 31 (the state indicated by 30A in FIG. 3), and the coil spring 77 on the outer circumference side deviates from the side face of the roll paper 30. In this state, the pressing force of the coil spring 77 on the outer circumference side exerts less influence, and instead that of the coil spring 76 that exhibits the lower elasticity, and that is on the inner circumference side exerts more influence. Namely, the side face of the roll paper 30 is pressed by the pressing plate 72 by a pressing force which is weaker than that in the case where the roll paper 30 has the maximum diameter. When the paper 31 is further consumed and the roll paper 30 has a small diameter as shown in FIG. 4(d) (the state indicated by 30B in FIG. 3), also the coil spring 76 on the inner circumference side deviates from the side face of the roll paper 30. In this state, only the pressing force of the coil spring 76 on the inner circumference side is applied to the side face of the roll paper 30.

As seen from the above-described operations, in the pressing unit 70, the pressing force which is applied to the side faces of the roll paper 30 by the pressing plates 72 is gradually reduced in accordance with reduction of the diameter of the roll paper 30. According to the pressing unit 70, the side faces of the roll paper 30 are pressed by the pressing plates 72, and hence overrun in which the roll paper 30 is caused to continue the rotation by an inertia force generated in the roll paper 30 when the printing process is stopped is restricted. Therefore, slack in the paper 31 due to overrun, and wrinkles or a bend in the paper 31 caused by the slack are prevented from occurring.

When the roll paper 30 is reduced in diameter and weight, the pressing force which is applied to the side faces of the roll paper 30 by the pressing unit 70 is gradually reduced in accordance with the reduction of the diameter of the roll paper 30. Therefore, the own weight of the roll paper 30 overcomes the pressing force of the pressing unit 70, so that the roll paper can be returned to the bottom portion of the roll paper holder unit 15. As a result, failures such as rubbing of the print surface, and wrinkles or a bend in the paper 31 which may be caused when a printing process is conducted in a state where the roll paper 30 is raised do not occur. In the case where a sensor which detects that the amount of the paper 31 is reduced and informs of the reduction in order to promote replacement of the paper 31 is disposed, the sensor can surely operate because the roll paper 30 always exists at the predetermined position in the roll paper holder unit 15.

The paper 31 is pulled out from the roll paper 30 by the function of rotation of the platen roller 51 which is rotated by the transportation motor. In the roll paper 30 in which a load is applied to the side faces in order to prevent overrun from occurring, a larger driving force for pulling out the paper 31 must be applied as the diameter of the roll paper 30 becomes smaller. In the embodiment, however, the load which is applied to the roll paper 30 by the pressing unit 70 is not constant. Namely, in “state where the roll paper 30 has a large diameter and the driving force for pulling out can be reduced,” the pressing unit 70 exerts a large pressing force, and, in “state where the roll paper 30 has a small diameter and the driving force for pulling out must be large,” the pressing force of the pressing unit 70 is reduced.

Therefore, the driving force which is to be produced by the transportation motor in order to pull out the paper 31 can be constant or substantially constant irrespective of the outer diameter and weight of the roll paper 30. As a result, even when the diameter of the roll paper 30 is reduced, an excessive load is not applied to the driving unit configured by the transportation motor and the reduction gear, and a stable operation of pulling the roll paper 30 can be attained. Moreover, it is possible to avoid a cost for enabling the driving unit to cope with an excessive load.

### (2) Second Embodiment

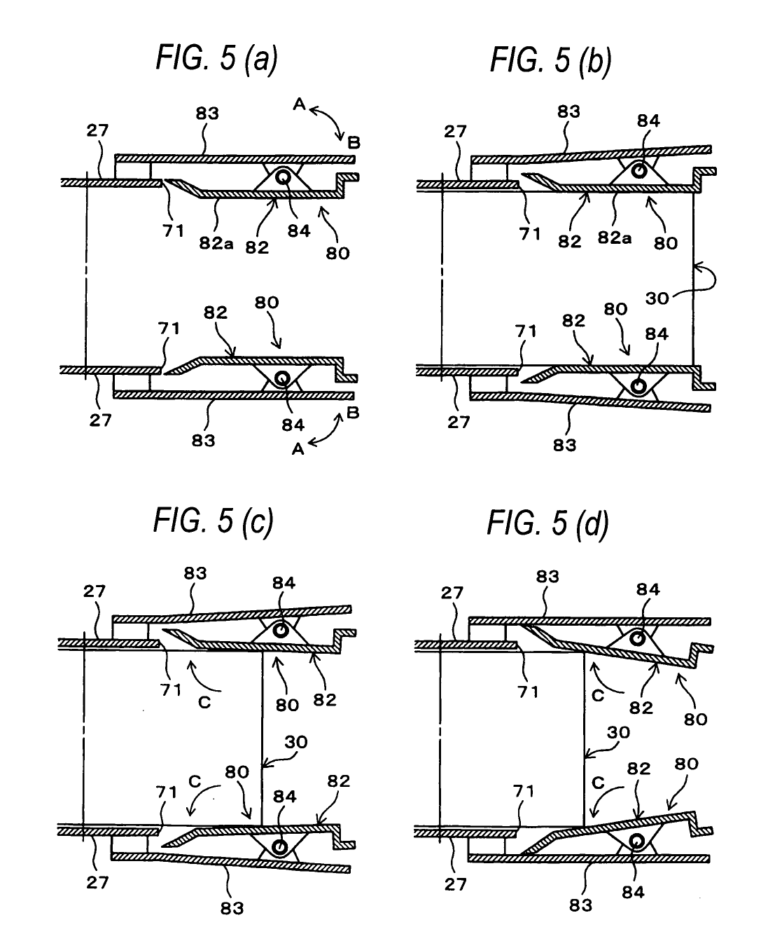

Next, a pressing unit 80 in a second embodiment which is another mode of the pressing unit 70 in the first embodiment will be described with reference to FIGS. 5(a) to 5(d).

In FIG. 5(a), 82 denotes pressing plates (pressing members) constituting the pressing unit 80 in the second embodiment. Each of the pressing plates 82 is configured in a similar manner as the pressing plate 72 in the first embodiment, but the claw 73 in the front-end portion is not formed, and the front-end portion and the claw 74 in the rear-end portion are not inserted into the cutaway 71 of the inner plate 27. In the embodiment, a rectangular plate spring 83 which longitudinally elongates is disposed in place of the spring seat plate 75 and the two coil springs 76, 77 in the first embodiment.

In the plate spring 83, a front-end portion which is an end portion in the direction of the length is cantilevered to the outer face of the inner plate 27 which is more forward than the cutaway 71. The plate spring can be elastically deformed about the cantilevered portion in the directions of the arrows A-B in FIG. 5(a). Corresponding one of the pressing plates 82 is swingably attached via a shaft 84 which vertically elongates, to a portion of the plate spring 83 which is slightly rearward than a middle portion in the direction of the length. In this case, the shafts 84 and the plate springs 83 constitute the swinging mechanism in the invention. As shown in FIG. 5(a), in a state where the roll paper holder unit 15 is empty, the plate spring 83 straightly elongates or is in a free state. At this time, the whole pressing face 82a of the pressing plate 82 slightly inward protrudes, so that the pressing face can butt against a side face of the roll paper 30.

In the pressing unit 80 in the second embodiment, as shown in FIG. 5(b), when the roll paper 30 loaded into the roll paper holder unit 15 has the maximum diameter, the pressing plate 82 is pressed by the side face of the roll paper 30 to cause the plate spring 83 to warp outward, the pressing plate 82 is swung about the shaft 84, and the whole pressing face 82a is in close contact with the side face of the roll paper 30. The side face of the roll paper 30 is pressed by the pressing plate 82 which receives the elasticity of the plate spring 83. At this time, the shaft (the journal portion of the pressing plate 82) 84 is opposed to the side face of the roll paper 30 across the pressing plate 82. In this case, therefore, the plate spring 83 warps at the maximum degree.

As shown in FIG. 5(c), then, the diameter of the roll paper 30 is reduced to about a half as a result of consumption of the paper 31, and the journal portion deviates from the side face of the roll paper 30, so that the pressing plate 82 is swung by the elasticity of the plate spring 83 about the shaft 84 in the direction of the arrow C, and the shaft 84 is inward moved. In the roll paper 30, the outer circumferential edge and the side face in the vicinity of the edge receive a pressing force from the pressing plate 82. At this time, the warp angle of the plate spring 83 is smaller than that in the case of FIG. 5(b), and hence the elasticity is reduced. As the butting position of the outer circumferential edge of the roll paper 30 against the pressing plate 82 is further more forward, the warp angle of the plate spring 83 is more reduced. In accordance with the reduction, also the elasticity is gradually reduced. When the paper 31 is further consumed and the roll paper 30 has a small diameter as shown in FIG. 5(d), the pressing plate 82 is further swung in the direction of the arrow C, and the front end of the plate butts against a portion of the plate spring 83 in the vicinity of the base of the spring. At this time, the plate spring 83 is in a free state, and the roll paper 30 hardly receives a pressing force from the pressing plate 82.

As described above, according to the pressing unit 80 in the second embodiment, the elasticity of the plate springs 83 is gradually reduced in accordance with reduction of the diameter of the roll paper 30, and hence also the pressing force which is applied to the side faces of the roll paper 30 by the pressing plates 82 is similarly reduced. In the same manner as the first embodiment, therefore, overrun of the roll paper 30 can be prevented from occurring, and moreover it is possible to attain various effects due to functions such as that, even when the roll paper 30 is reduced in diameter and weight, the roll paper is not kept to be raised, but is returned by its own weight to the predetermined position, and that the paper 31 can be pulled out by a constant driving force.

### (3) Third Embodiment

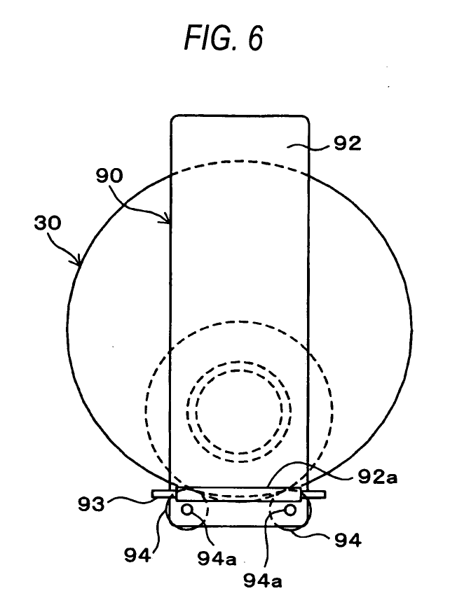

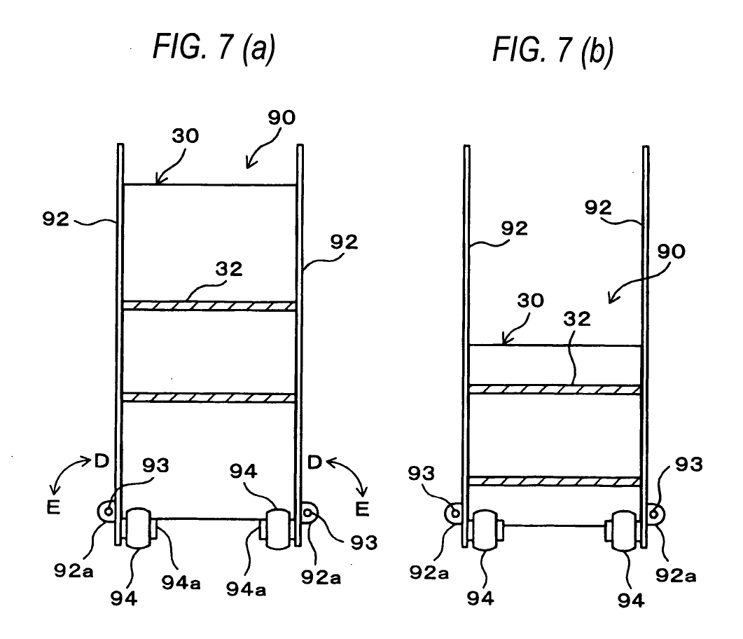

FIGS. 6, 7(a) and 7(b) are diagrams schematically showing a third embodiment in which the side faces of the roll paper 30 are pressed with using the own weight of the roll paper 30. In the embodiment, a roll paper holder unit (holding unit) 90 is of the drop-in type, and configured by a pair of right and left pressing plates (pressing members) 92. The pressing plates 92 have a rectangular shape which is longer than the maximum diameter of the roll paper 30, and are incorporated so as to, in a state where the roll paper 30 is loaded, vertically extend and oppose each other in parallel so as to hold the roll paper 30 therebetween.

In each of the pressing plates 92, a bearing 92a is formed on the outer face of an end portion (the lower portion in FIGS. 6, 7(a) and 7(b)), and a support shaft 93 which horizontally elongates is passed through the bearing 92a. The support shafts 93 are fixed to the frame (not shown) or the like of the printer so as to be parallel to each other, thereby enabling the pressing plates 92 to be swingable via the support shafts 93 in the directions of the arrows D-E in FIG. 7(a). In each of the pressing plates 92, a pair of front and rear rollers 94 are swingably supported on the inner side which is closer to the lower end side than the bearing 92a, via horizontal roller shafts 94a which are perpendicular to the support shafts 93. In this case, the pressing plates 92, the support shafts 93, and the rollers 94 constitute the link mechanism in the invention.

In the roll paper holding mechanism, the roll paper 30 is placed on the right and left rollers 94. Then, the pressing plates 92 are swung about the support shafts 93 in the directions of the arrows D in FIG. 7(a), so that the inner faces of the plates are in close contact with the side faces of the roll paper 30, respectively, and the side faces of the roll paper 30 are pressed by the pressing plates 92 by a force corresponding to the own weight of the roll paper 30. In accordance that the paper is pulled out to be consumed, the roll paper 30 is reduced in diameter as shown in FIG. 7(b) and also the weight is reduced, and hence the pressing force which is applied to the roll paper by the pressing plates 92 is reduced. Moreover, the pressing force is reduced also by reduction of friction due to decrease of the area of the side faces of the roll paper 30 which are in close contact with the inner faces of the pressing plates 92.

### (4) Fourth Embodiment

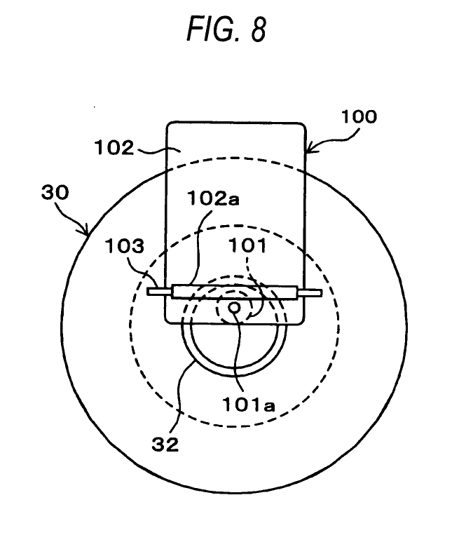

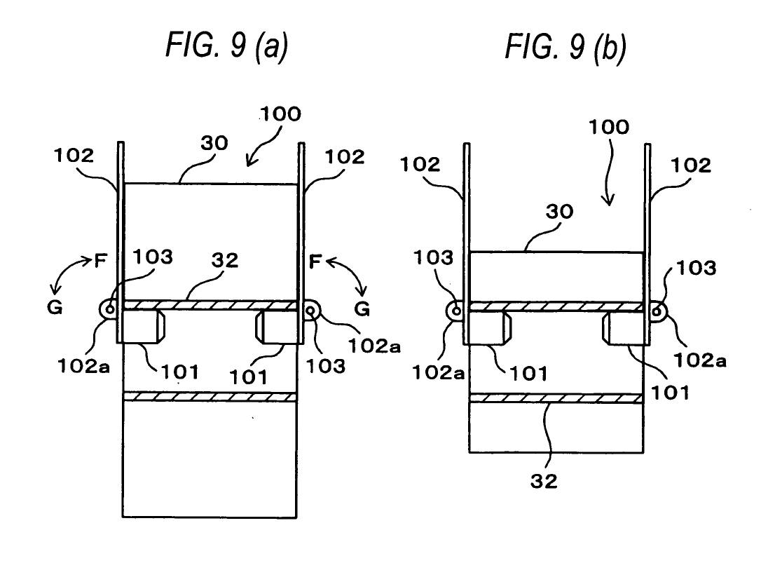

FIGS. 8, 9(a) and 9(b) are diagrams schematically showing a roll paper holding mechanism in which the side faces of the roll paper 30 are pressed with using the own weight of the roll paper 30 in a similar manner as the third embodiment. In the embodiment, a roll paper holder unit (holding unit) 100 is of the shaft-supporting type in which the roll paper 30 is rotatably supported by a pair of right and left rollers 101 that are inserted into the core member 32. The rollers 101 are rotatably supported by a pair of right and left pressing plates (pressing members) 102, respectively. The pressing plates 102 are similar to the pressing plates 92 in the third embodiment, and have a bearing 102a in respective lower end portions. The pressing plates are swingable in the directions of the arrows F-G in FIG. 9(a) via support shafts 103 which are passed through the bearings 102a, and which are fixed to frames that are not shown, respectively. Each of the rollers 101 is rotatably supported on a middle portion in the width direction of the inner side of the corresponding pressing plate 102 which is closer to the lower end side than the bearing 102a, via a horizontal roller shaft 101a which is perpendicular to the support shafts 103. One of the frames which are not shown, and to which the support shafts 103 are fixed is movable in the lateral directions in FIG. 9(a), and also fixable. When the roll paper 30 is to be set, the frame is first moved to the outside, the roll paper 30 is then set, and the frame is then moved to the inside and fixed. In this case, the pressing plates 102, the support shafts 103, and the rollers 101 constitute the link mechanism in the invention.

In the roll paper holding mechanism, the right and left rollers 101 are inserted into the core member 32, and the roll paper 30 is rotatably supported in a state where the roll paper hangs from the rollers 101. In this state, the right and left pressing plates 102 are swung about the support shafts 103 in the directions of the arrows F in FIG. 9(a), so that the inner faces of the plates are in close contact with the side faces of the roll paper 30, respectively, and the side faces of the roll paper 30 are pressed by the pressing plates 102 by a force corresponding to the own weight of the roll paper 30. The pressing plates 102 are slightly longer than the maximum radius of the roll paper 30, and hence press the portion of the roll paper 30 which is above the core member 32. In accordance that the paper is pulled out to be consumed, the roll paper 30 is reduced in diameter as shown in FIG. 9(b) and also in weight, and hence the pressing force which is applied to the roll paper by the pressing plates 102 is reduced.

In the roll paper holding mechanisms of the third and fourth embodiments, the side faces of the roll paper 30 are pressed by the pressing plates 92 or 102 by the own weight of the roll paper, and, in accordance that the roll paper 30 is consumed and the diameter is reduced, the pressing force applied by the pressing plates 92 or 102 is gradually reduced. Also in the embodiments, in the same manner as the first and second embodiments, therefore, it is possible to attain the effects due to functions such as that overrun of the roll paper 30 can be prevented from occurring, and that the paper can be pulled out by a constant driving force. In the third embodiment which is of the drop-in type, moreover, the failure due to the state where the roll paper 30 remains to be raised can be prevented from occurring.

1. A roll paper holding mechanism comprising:
a holding unit which rotatably holds a roll paper;
a driving unit which pulls out a leading portion of the roll paper held by the holding unit; and
a pressing unit which presses a side face of the roll paper held by the holding unit, wherein the pressing unit comprises a pressing force adjusting section for gradually reducing a pressing force in accordance with reduction of a diameter of the roll paper.

2. A roll paper holding mechanism according to claim 1, wherein the pressing force adjusting section comprises a plurality of elastic members which are arranged substantially along a direction of reducing the diameter of the roll paper, and in a sequence in which an elasticity is further reduced as advancing in the diameter reducing direction.

3. A roll paper holding mechanism according to claim 1, wherein the pressing unit comprises a pressing member which butts against the side face of the roll paper, and
the pressing force adjusting section comprises a swinging mechanism which gradually swings the pressing member in one direction in accordance with reduction of the diameter of the roll paper.

4. A roll paper holding mechanism according to claim 1, wherein the pressing unit comprises a pressing member which butts against the side face of the roll paper, and
the pressing force adjusting section comprises a link mechanism which urges the pressing member by a pressure corresponding to an own weight of the roll paper.

5. A printer comprising a roll paper holding mechanism including:
a holding unit which rotatably holds a roll paper;
a driving unit which pulls out a leading portion of the roll paper held by the holding unit; and
a pressing unit which presses a side face of the roll paper held by the holding unit,
wherein the pressing unit comprises a pressing force adjusting section for gradually reducing a pressing force in accordance with reduction of a diameter of the roll paper.

6. A printer according to claim 5, wherein the pressing force adjusting section comprises a plurality of elastic members which are arranged substantially along a direction of reducing the diameter of the roll paper, and in a sequence in which an elasticity is further reduced as advancing in the diameter reducing direction.

7. A printer according to claim 5, wherein the pressing unit comprises a pressing member which butts against the side face of the roll paper, and
the pressing force adjusting section comprises a swinging mechanism which gradually swings the pressing member in one direction in accordance with reduction of the diameter of the roll paper.

8. A printer according to claim 5, wherein the pressing unit comprises a pressing member which butts against the side face of the roll paper, and
the pressing force adjusting section comprises a link mechanism which urges the pressing member by a pressure corresponding to an own weight of the roll paper.
